(19) United States
(12) Patent Application Publication
(10) Pub. No.: US 2002/0162392 A1
(43) Pub. Date: Nov. 7, 2002

(54) Vibration sensing assembly

(76) Inventor: Jung-Tsung Wei, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/839,494

(22) Filed: Apr. 23, 2001

(51) Int. Cl. G01H 17/00; G01N 24/00

(52) U.S. Cl. 73/570; 73/1.82

(57) ABSTRACT

A vibration sensing assembly includes a vibration sensor which is connected to a thread and sends a signal to a signal control unit when a vibration is received by the vibration sensor. The signal control unit sends a signal to an activator such as a relay to activate a fan, light or the like. The signal sent to the activator may be sent by infra-red beam or electric wave, and the signal can be processed by encoding-decoding processes.

### FIELD OF THE INVENTION

The present invention relates to a vibration sensing assembly connected to a light device and has a sensor which sends signals when receiving vibration and activates light or the like.

### BACKGROUND OF THE INVENTION

A conventional ceiling light such as shown in FIG. 1 generally includes a frame 30 for two light tubes 31 connected thereto and a thread 32 extends from a switch in the frame 30. When the thread 32 is pulled, the switch is activated and the light tubes 31 are turned on or off. A similar way to switch a lamp 33 as shown in FIG. 2 is also used for a long time. The thread 32 provides a visible means for the users to find and pull. However, when the user enters a dark room, he/she has to find the position of the thread 32 so as to turn the light on. This is not convenient and could be dangerous because the user may fall down if he/she hits on an object in the dark. Besides, The switch connected with the thread 32 is a mechanical switch which will be damaged because of wear out after the switch is used for a period of time. When a gap is defined between parts in the switch, sparks could be produced when operating the switch and cause fire. Although the switches can be installed on the walls so that when the users enter a room, the users' hand can find the switches and activate the switches. However, it is experienced that the wall around the switch is always dirty because the users' hand touch the wall when they search the switches.

The present invention intends to provide a vibration sensing assembly which is activated by simply receiving a vibration.

### SUMMARY OF THE INVENTION

In accordance with one aspect of the present invention, there is provided a vibration sensing assembly and comprises a power supply connected to a vibration sensor, a delay control unit, a latch control unit and a signal control unit respectively. The vibration sensor sends an unstable signal to the delay control unit which sends the unstable signal after counting a preset period of time to the latch control unit which converts the unstable signal into a stable signal and sends the stable signal to the signal control unit. An activator powered by the power supply is activated by receiving the stable signal from the signal control unit and a controlled device is activated by the activator.

The primary object of the present invention is to provide a vibration sensing assembly connected to a light device so that the light is activated by receiving a vibration from any direction.

The present invention will become more obvious from the following description when taken in connection with the accompanying drawings which show, for purposes of illustration only, three preferred embodiments in accordance with the present invention.

### BRIEF DESCRIPTION OF THE DRAWINGS

FIG. 1 is a perspective view to show a ceiling light with a conventional pull switch;

FIG. 2 is a perspective view to show a table light with a conventional pull switch;

FIG. 3 is an illustrative view to show the vibration sensor of the present invention is connected to a thread;

FIG. 4 is a diagram to show a first embodiment of the vibration sensing assembly of the present invention;

FIG. 5 is a diagram to show a second embodiment of the vibration sensing assembly of the present invention;

FIG. 6 is a diagram to show a third embodiment of the vibration sensing assembly of the present invention;

FIG. 7 is an illustrative view to show that the vibration sensor is hanged on a door;

FIG. 8 is an illustrative view to show that the vibration sensor is hanged on a door, a window and a table light respectively, and

FIG. 9 is an illustrative view to show that the thread can be spirally-curled.

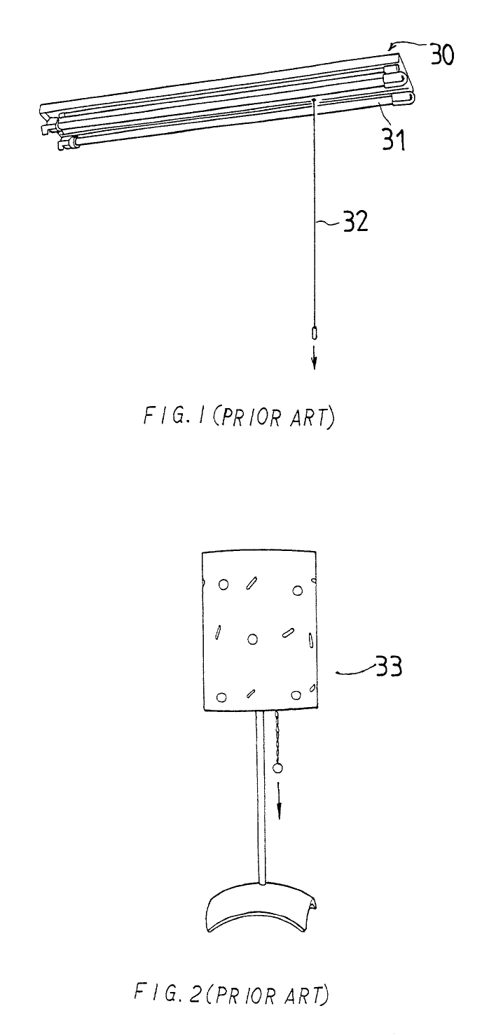

### DETAILED DESCRIPTION OF THE PREFERRED EMBODIMENTS

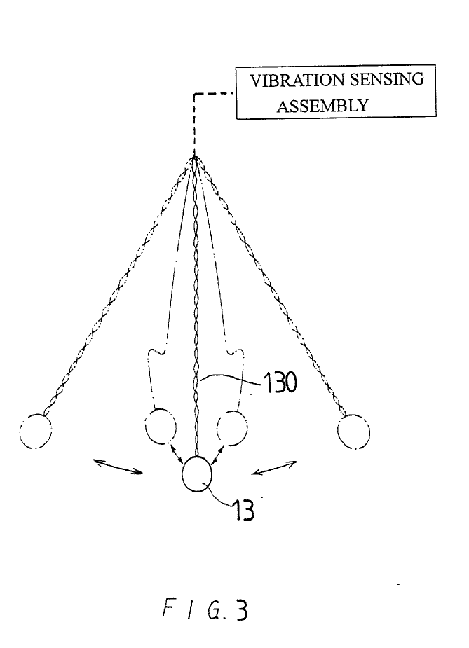

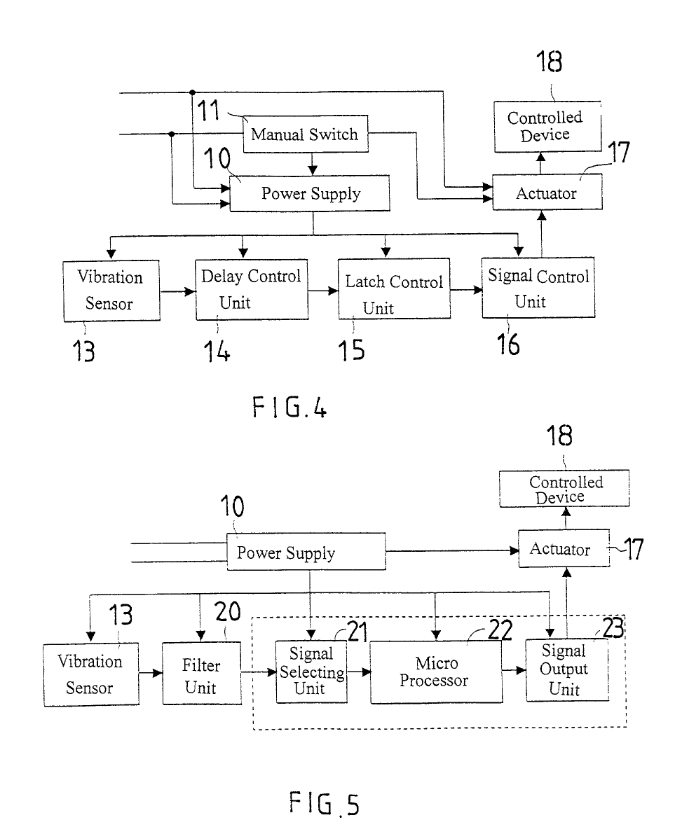

Referring to FIGS. 3 and 4, the vibration sensing assembly of the present invention comprises a power supply 10 connected to a vibration sensor 13, a delay control unit 14, a latch control unit 15, an activator 17 and a signal control unit 16 respectively. The vibration sensor 13 can be hanged on a thread 130 and sends an unstable signal to the delay control unit 14 when a vibration is received by the vibration sensor 13. The delay control unit 14 sends the unstable signal after counting a preset period of time to the latch control unit 15 which converts the unstable signal into a stable signal and sends the stable signal to the signal control unit 16. During the period of delay, the latch control unit 15 will not receive other signal. The activator 17 is activated by receiving the stable signal from the signal control unit 16 and then actives a controlled device 18. The activator 17 is a relay, an electro-magnetic switch or a solid state relay. The controlled device 18 can be a fan, a light or even a siren. The activator 17 is also connected with a manual switch 11 so that the user may operate the manual switch 11 directly.

Referring to FIG. 5, the vibration sensing assembly may includes a power supply 10 connected to a vibration sensor 13, a filter unit 20, a signal selecting unit 21 a micro processor 22, a signal output unit 23 and an activator 17. The vibration sensor 13 sends a signal to the filter unit 20 which filters and amplifies the signal and sends the signal to the signal selecting unit 21 which picks the signals and sends a stable signal to the micro processor 22. The signal is processed by the micro processor 22 and sent to an activator 17 via the signal output unit 23. A controlled device 18 is then activated by the activator 17. The features of the micro processor 22 can be controlled by software so as to have desired features and an integral circuit board is employed to include more functions.

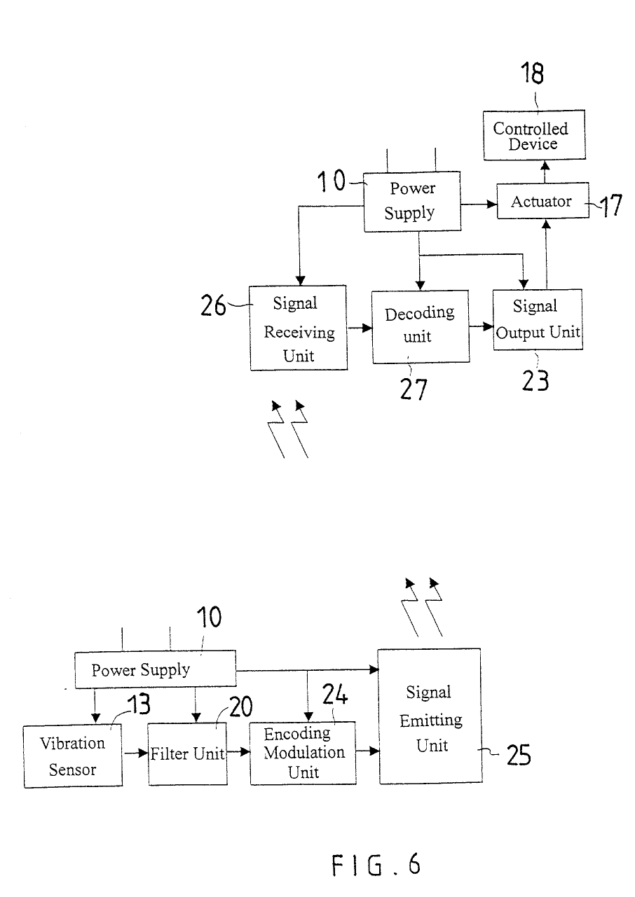

Referring to FIG. 6, the vibration sensing assembly comprises a power supply 10 connected to a vibration sensor 13, a filter unit 20, an encoding modulation unit 24, a signal emitting unit 25, a signal receiving unit 26, a decoding unit 27, a signal output unit 23 and an activator 17. The vibration sensor 13 sends a signal to the filter unit 20 which filters and amplifies the signal and sends the signal to the encoding modulation unit 24 which sends a stable signal to the signal receiving unit 26 via the signal emitting unit 25. The signal received by the signal receiving unit 26 is then decoded by the decoding unit 27 and sent to the signal output unit 23 which sends a signal to the activator 17 so as to activate a controlled device 18. The way that the signal emitting unit 25 sends can be by infra-red beams or electric waves.

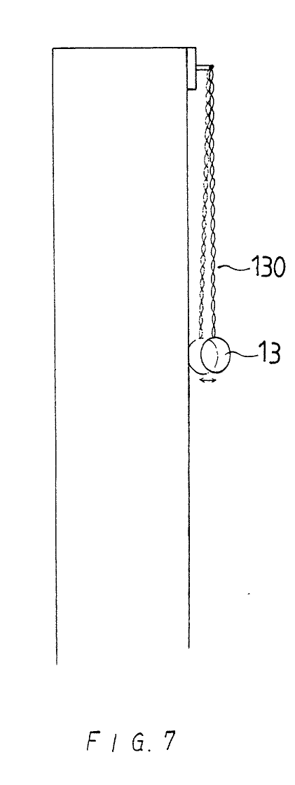

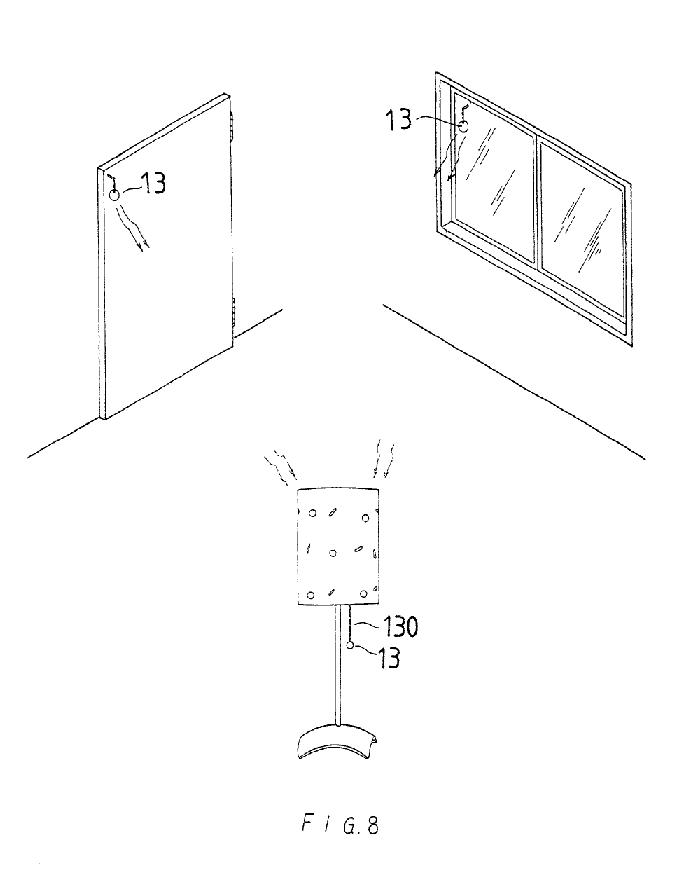

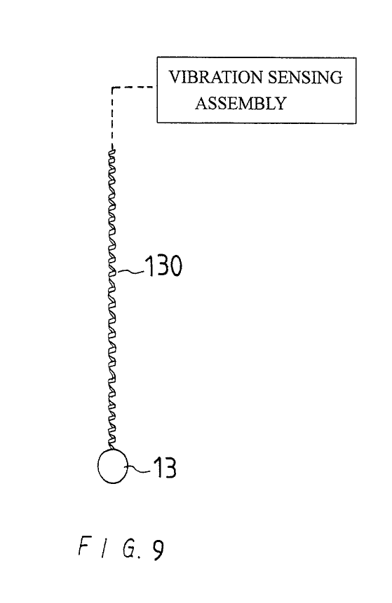

As shown in FIG. 7, the vibration sensor 13 is hanged on a thread 130 which is connected to a top of a door so that when the door is opened, a vibration is sensed by the vibration sensor 13 and the light is activated by the vibration sensing assembly. FIG. 8 shows that multiple vibration sensors 13 are connected with the door, the window and the table light, either of the door or the door is opened, the table light is turned on. The table light can be replaced by a siren which provides a warning device. FIG. 9 shows that the thread 130 can be made to be spirally curled which has proper bounce feature and can be pulled to extend. The vibration sensor 13 can be a fluorescent member so that the users can find the vibration sensor 13 without difficulties.

While we have shown and described the embodiments in accordance with the present invention, it should be clear to those skilled in the art that further embodiments may be made without departing from the scope of the present invention.

What is claimed is:

1. A vibration sensing assembly comprising:
a power supply connected to a vibration sensor, a delay control unit, a latch control unit and a signal control unit respectively, said vibration sensor sending an unstable signal to said delay control unit which sends said unstable signal after counting a preset period of time to said latch control unit which converts said unstable signal into a stable signal and sends said stable signal to said signal control unit;
an activator powered by said power supply and activated by receiving said stable signal from said signal control unit, and
a controlled device being activated by said activator.

2. The assembly as claimed in claim 1, wherein said vibration sensor is connected to a thread.

3. The assembly as claimed in claim 1, wherein said activator is a relay.

4. The assembly as claimed in claim 1, wherein said activator is an electro-magnetic switch.

5. The assembly as claimed in claim 1, wherein said activator a solid state relay.

6. A vibration sensing assembly comprising:
a power supply connected to a vibration sensor, a filter unit, a signal selecting unit, a micro processor, and a signal output unit, said vibration sensor sending a signal to said filter unit which filters and amplifies said signal and sends said signal to said signal selecting unit which sends a stable signal to said micro processor, said signal being processed by said micro processor and sent to an activator via said signal output unit, said activator powered by said power supply, and
a controlled device being activated by said activator.

7. The assembly as claimed in claim 6, wherein said vibration sensor is connected to a thread.

8. The assembly as claimed in claim 6, wherein said activator is a relay.

9. The assembly as claimed in claim 6, wherein said activator is an electro-magnetic switch.

10. The assembly as claimed in claim 6, wherein said activator a solid state relay.

11. A vibration sensing assembly comprising:
a power supply connected to a vibration sensor, a filter unit, an encoding modulation unit, a signal emitting unit, a signal receiving unit, a decoding unit and a signal output unit, said vibration sensor sending a signal to said filter unit which filters and amplifies said signal and sends said signal to said encoding modulation unit which sends a stable signal to said signal receiving unit via said signal emitting unit, said signal received by said signal receiving unit being decoded by said decoding unit and sent to said signal output unit which sends a signal to an activator, and
a controlled device being activated by said activator.

12. The assembly as claimed in claim 11, wherein said vibration sensor is connected to a thread.

13. The assembly as claimed in claim 11, wherein said activator is a relay.

14. The assembly as claimed in claim 11, wherein said activator is an electro-magnetic switch.

15. The assembly as claimed in claim 11, wherein said activator is a solid state relay.

16. The assembly as claimed in claim 11, wherein said signal emitting unit sends said signal by infra-red beams.
